(19) United States
(12) Patent Application Publication
(10) Pub. No.: US 2012/0024409 A1
(43) Pub. Date: Feb. 2, 2012

(54) PLUG CONNECTION

(76) Inventor: Thomas KUNZMANN, Walzbachtal (DE)

(21) Appl. No.: 13/190,537

(22) Filed: Jul. 26, 2011

(30) Foreign Application Priority Data
Jul. 31, 2010 (DE) 10 2010 032 983.5

(51) Int. Cl. F16L 55/10

(52) U.S. Cl. 138/89

(57) ABSTRACT

The invention relates to a plug connection that comprises a housing (1) with a receiving opening (2), for the insertion of a connection pipe (3), and a connection part associated with the receiving opening (3) for retaining the connection pipe (3) in the housing (1). The connection portion contains a clamping element (10) with several clamping segments (12), mutually separated by slots (11), and a supporting element (15), which works in cooperation with the clamping element (10), wherein the supporting element (15) presents mutually separated retaining tongues (16) for engagement in the slots (11) of the clamping element (10), and wherein the clamping segments (12) of the clamping element (10) contain conical outer surfaces (13) for application against a conical inner surface (14) of the receiving opening (2).

### CROSS REFERENCE TO RELATED APPLICATIONS

This application claims priority under 35 U.S.C. §119 to German Patent Application No. 102010032983.5 filed Jul. 31, 2010, the entire contents of which are incorporated herein by reference.

### FIELD OF THE INVENTION

The invention relates to a plug connection.

### BACKGROUND OF THE INVENTION

A plug connection of this type is known from DE-PS 1 235 691. In said plug connection, the connection part, arranged within a receiving opening of a sleeve-shaped housing, and intended for retaining a connection pipe in the housing, consists of a metal clamping ring provided with a longitudinal slot. On its outer side, the clamping ring presents a conicity that corresponds to a portion of the receiving opening, which extends conically to the end of the housing. During the setting up of this plug connection, the connection pipe must be inserted into the receiving opening of the sleeve-shaped housing up to an abutment, and subsequently retracted, until the clamping ring comes to be applied with its conical outer side against the corresponding conical inner part of the receiving opening. Although such a plug connection presents a simple design, it nonetheless has the drawback that, in case of a subsequent removal of the connection line, additional auxiliary tools are required. Said tools must be inserted between the pipe and the clamping ring, to be able to pull out the pipe without friction.

Several multipart plug connections with a clamping ring arranged within a housing and a clamping nut that works in cooperation with the clamping ring, and that are connected via an outer threading to an inner threading of the housing, are already known. By screwing the clamping nut into the housing, the clamping ring can be warped and pressed against the connection pipe. However, due to the threaded connection between becomes [sic] the clamping nut and the housing, the setting up and removal of such a plug connection become more difficult.

### SUMMARY OF THE INVENTION

The problem of the invention is to produce a plug connection of the type mentioned in the introduction, which allows a simplified setting up and removal.

Advantageous variants and advantageous embodiments of the invention are the object of the dependent claims.

In the plug connection according to the invention, the connection part comprises a clamping element with several clamping segments separated from each other by slots, and with a supporting element that works in cooperation with the clamping element, wherein the supporting element presents mutually separated retaining tongues for engagement into the slot of the clamping element, and wherein the clamping segments of the clamping element contain conical outer surfaces for application against a conical inner surface of the receiving opening. As a result of the collaboration between the clamping element and supporting element, a secure retention of the connection pipe, and a simple setting up or removal becomes possible, even without special tools. The clamping element, which has the design of a collet, guarantees a good and secure clamping, while the supporting element with the retaining tongues engaging in the slots of the clamping element, prevents excessive deformation of the clamping segments, and consequently deformation of the connection pipe. By axial shifting of the clamping element and of the supporting element, the plug connection can be pretensioned or loosened in a simple manner.

In an advantageous embodiment, the retaining tongues of the supporting element also present on their outer side conical outer surfaces for application against the conical inner surface of the receiving opening. As a result, a good clamping effect is achieved.

A particular good clamping can be achieved by providing retaining teeth on the inner side of the clamping segment.

In an embodiment that is advantageous in terms of manufacturing technology, the clamping element and the supporting element are manufactured from plastic. They can also be manufactured from another suitable material.

A securing element designed as a protective bushing is advantageously associated with the clamping element. By means of this securing element, on the one hand, the parts of the plug connection arranged within the housing are protected from soiling, and, on the other hand, the clamping element and the supporting element are held together.

### BRIEF DESCRIPTION OF THE DRAWINGS

Special features and advantages of the invention can be obtained from the following description of a preferred embodiment example in reference to the drawing. The figures show:

FIG. 1, a plug connection in a cross-sectional exploded view;

FIG. 2, the plug connection of FIG. 1 before the insertion of a connection pipe, in a longitudinal cross section;

FIG. 3, the plug connection of FIG. 1 with inserted and firmly clamped connection pipe, in a longitudinal cross section;

FIG. 4, a clamping element of the plug connection of FIG. 1 in a perspective view;

FIG. 5, a supporting element of the plug connection of FIG. 1 in a perspective view, and

FIG. 6, a retaining element of the plug connection of FIG. 1 in a perspective view.

### DETAILED DESCRIPTION OF THE INVENTION

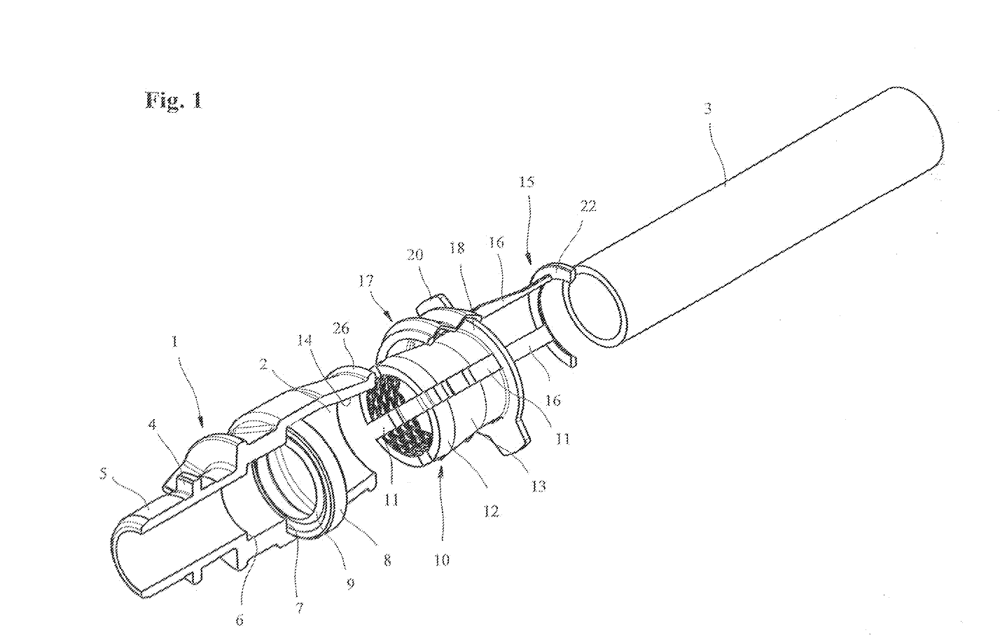

The plug connection, shown in a cross-sectional exploded view in FIG. 1, which is used to connect connection pipes made of plastic to indoor connection fixtures, contains a hollow cylindrical housing 1, consisting, for example, of ductile cast iron with an epoxide coating, and containing a receiving opening 2 for plugging in a connection pipe 3, made, for example, of polyethylene, PEX or another suitable plastic. On the side turned away from the receiving opening 2, the housing 1 presents a connector 5, which is provided with coupling elements 4 of a quick coupling device, a threading or other connection parts, for connecting the housing 1 to a pipe bridge or the like.

The receiving opening 2 of the housing 1 contains an inner ring-shaped shoulder 6, as abutment for the connection pipe 3, and an inner ring shoulder 7, for the application of a ring-shaped sealing 8. The sealing 8 presents on its inner side a sealing lip 9 for the sealing application against the outer side of the connection pipe 3. The plug connection comprises, furthermore, a sheath-shaped clamping element 10, which can be inserted into the receiving opening 2 of the housing 1, which contains clamping elements 12 that are separated from each other by slots 11 and flexible in the radial direction, and have conical outer surfaces 13 for application against a conical application surface 14 inside the receiving opening 2. The plug connection comprises, furthermore, a supporting element 15 that works in cooperation with a clamping element 10, and that contains mutually separated retaining tongues 16 for engagement in the slots 11 of the clamping element 10.

In addition, a securing element 17, designed here as a protective bushing and explained in further detail below, is associated with the securing element 15.

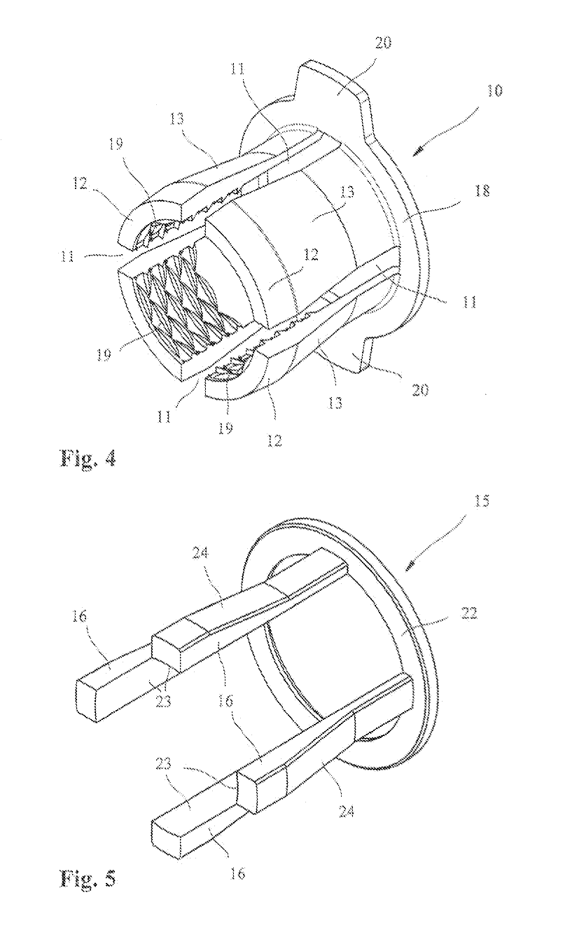

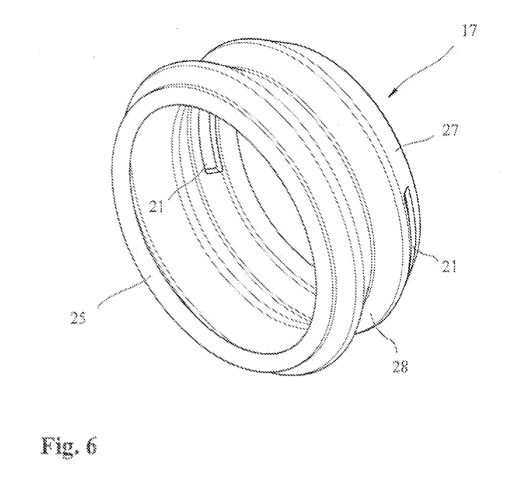

As is apparent from FIG. 4, the clamping element 10, which is designed like a collet or a clamping sleeve and preferably manufactured from plastic, presents, in the shown embodiment, four ring segment-shaped clamping segments 12, which are mutually separated in the peripheral direction by the slots 11, and which are formed at one of their ends on a collar 18. At the other ends of the clamping segments 12 that protrude from the collar 18 and are radially springy, retaining teeth 19 are formed on the inner side. The conical outer surfaces 13 provided on the outer side of the claming segments are intended for application against the corresponding conical inner application surface 14 of the housing 1. In addition, radially protruding retaining brackets 20 are formed on the outer side of the collar 18, for engagement with the recesses 21, represented in FIG. 6, of the securing element 17 designed as a protective bushing.

The supporting element 15 represented in FIG. 5 contains four protruding retaining tongues 16, which are formed on a supporting ring 22 and whose shape is adapted to the slots 11 of the clamping element 10 shown in FIG. 4. The retaining tongues 16 are also formed with radial springiness on the supporting ring 22, and designed in such a manner that they complement the clamping element 10 designed as a collet or a clamping sheath, at the time of the insertion of the supporting element 15, to form a clamping sheath that encloses the connection pipe 3 nearly completely. The retaining tongues presents [sic] inner round application surfaces 23 for application against the outer side of the connection pipe 3, and conical outer surfaces 24 for application against the conical application surface 14 inside the receiving opening 2 of the housing 1.

FIG. 6 shows the securing element 17 designed as a protective bushing. The securing element 17 contains a ring-shaped front area 25 to retain an annular bead 26 shown in FIG. 1, at the end of the housing 1 that is provided with the receiving opening 2. The securing element 17 presents, furthermore, a ring-shaped rear area 27 for the application and retention against the collar 18 of the clamping element 10. In the rear area 27, the slit-shaped recesses 21 for the retaining bars 20 are provided. Between the ring-shaped front and rear areas, the securing element 17, which is preferably made of rubber, is designed as a cylindrical bellows 28.

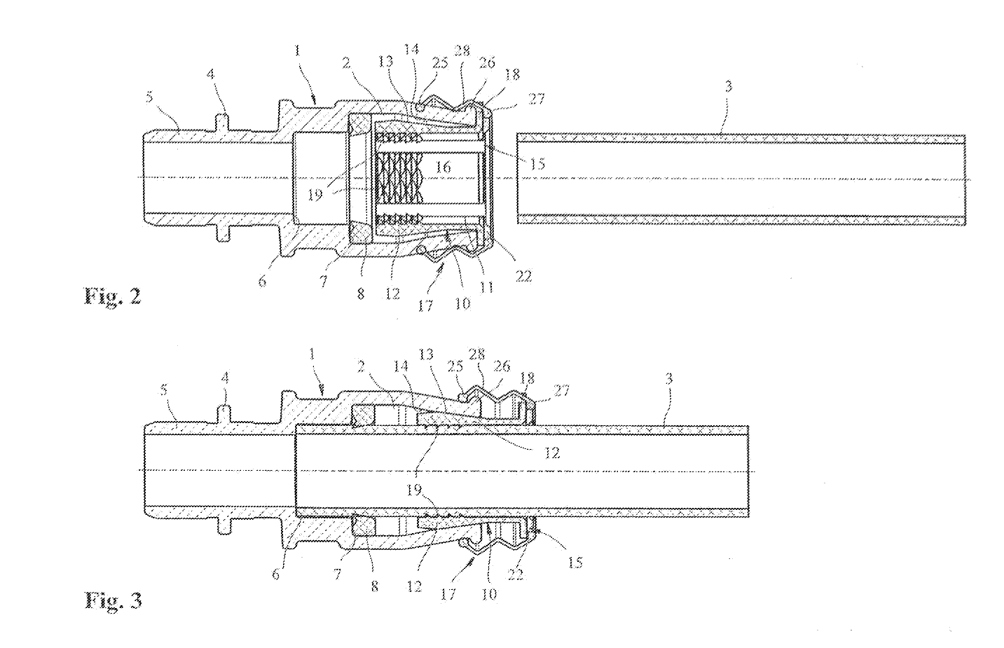

Below, the operation and the setting up or removal of the above-described plug connection are explained in reference to FIGS. 2 and 3.

The plug connection can be delivered as a preassembled and ready-for-installation unit according to FIG. 2 with the ring-shaped sealing 8 inserted into the housing 1, the sheath-shaped clamping element 10 inserted into the housing 1, the supporting element 15 inserted into the clamping element 10, and the securing element 17, which is designed as a sealing bushing, slipped onto the housing 1. The springy clamping segments 12 of the sheath-shaped clamping element 10, due to the slots 11, can be pressed radially inwards, so that the sheath-shaped clamping element 10 can be inserted into the receiving opening 2 of the housing 1, which narrows outwardly. Subsequently, the supporting element 15 is inserted into the clamping segment 10 in such a manner that the retaining tongues 16, which also present springiness, reach into the slots 11.

If the clamping element 10 and the supporting element 15 are in the inserted position shown in FIG. 2 and the collar 18 of the clamping element 10 is applied against the front surface of the housing 1, the clamping segments 12 and the retaining tongues 16 can be applied radially with springiness. By means of the securing element 17, which is designed as a supporting bushing, on the one hand, the parts of the plug connection arranged inside the housing 1 are protected from soiling, and, on the other hand, the clamping element 10 and the supporting element 15 are held together in the recesses 21 of the supporting element 15, when the retaining bars 20 of the clamping element 10 are pushed through. Because the outer shape of the securing element 17 corresponds to a springy bellows, sufficient axial flexibility is achieved for the setting up or removal of the inner components of the plug connection.

For the setting up of the connection pipe 3, the clamping element 10 and the supporting element 15 are shifted on the retaining bars 20 of the clamping element 10 inwards into the housing 1 until the collar 18 is applied against the front surface of the housing 1. As a result, a sufficient clearance is formed between the conical outer surfaces 13 and 24 of the clamping segments 12 or retaining tongues 16, and the conical application surface 14 on the inner side of the housing 1, so that the clamping segments 12 and the retaining tongues can be applied with springiness at the time of the insertion of the connection pipe 3. The connection pipe 3 is inserted through the sealing 8 into the housing 1 until the pipe front surface abuts against the shoulder 6. Then, the clamping element 10 and supporting element 15 are pulled axially outwards at the retaining bars 20 until the conical outer surfaces 13 and 24 of the clamping segments 12 or retaining tongues 16 are applied without clearance against the conical inner application surface 14 of the housing 1. The retaining teeth 19 of the clamping element 10 now lie directly against the connection pipe 3. Any additional pulling force exerted on the connection pipe 3 leads to the penetration of the retaining teeth 19 into the connection pipe 3, and thus to the buildup of a retaining force.

To prevent the clamping segments 12 from being able to move radially inwards over a distance of any length at the time of the compression by the reaction forces between conical surfaces 13 and the conical inner application surface 14 of the housing 1, which could lead to a polygonal deformation of the connection pipe and possibly to a pulling of the clamping element 10 out of the housing 1, the retaining tongues 16 of the supporting element 15 are located in the slots 11 of the clamping element 10. They prevent, due to radial application, an excessive deformation of the entire unit, thus preventing the axial pulling out of the connection pipe 3.

For the removal of the connection pipe 3, the clamping element 10 and the supporting element 15 now have to be inserted axially into the housing 1 until the collar 18 comes to be applied against the front surface of the housing 1. As a result, sufficient clearance is formed between the conical outer surfaces 13 and 24 of the clamping segments 12 or retaining tongues 16 and the conical inner application surface 14 of the housing 1, such that the clamping segments 12 and the retaining tongues 16 can be applied with springiness. As a result, the clamping between the retaining teeth 19 and the connection pipe 3 is eliminated, so that the latter can be pulled out of [the housing] 1.

After a removal of a connection pipe 3, the clamping element 10 and the supporting element 15 have to be exchanged prior to a new setting up, because the retaining teeth 19 as a rule suffer prior damage. In the process, the securing element 17 designed as a protective bushing is first pulled off the housing 1, and then the supporting element is pulled out of the housing 1. After the retaining tongues 16 have been removed from the slots 11 of the clamping element 10, the clamping segments 12 can again present inward springiness, and the clamping element 10 can be pulled out of the receiving opening 2 of the housing 1.

While various descriptions of the present invention are described above, it should be understood that the various features can be used singly or in any combination thereof. The invention described and claimed herein is not to be limited in scope by the specific embodiments herein disclosed, since these embodiments are intended solely as illustrations of several aspects of the invention. Any equivalent embodiments are intended to be within the scope of this invention. Indeed, various modifications of the invention in addition to those shown and described herein will become apparent to those skilled in the art from the foregoing description. Such modifications are also intended to fall within the scope of the appended claims.

What is claimed is:

1. Plug connection, which comprises a housing with a receiving opening, for the insertion of a connection pipe, and a connection part associated with the receiving opening for retaining the connection pipe in the housing, wherein the connection part contains a clamping element with several clamping segments separated from each other by slots, and a supporting element that works in cooperation with the clamping element, wherein the supporting element presents mutually separated retaining tongues for engagement in the slots of the clamping element, and wherein the clamping segments of the clamping element contain conical outer surfaces for the application against a conical inner surface of the receiving opening.

2. Plug connection according to claim 1, wherein the retaining tongues present, on their outer side, conical outer surfaces for the application against the conical inner surface of the receiving opening.

3. Plug connection according to claim 1, wherein the clamping segments of the clamping element are formed on a collar.

4. Plug connection according to claim 1, wherein the retaining tongues of the supporting element are formed on a supporting ring.

5. Plug connection according to claim 1, wherein the retaining tongues are provided on the inner side of the clamping segments.

6. Plug connection according to claim 1, wherein the clamping element and the supporting element are manufactured from plastic.

7. Plug connection according to claim 1, wherein a securing element is associated with the clamping element.

8. Plug connection according to claim 7, wherein the securing element is designed as a protective bushing with a cylindrical bellows.

9. Plug connection according to claim 7, wherein the securing element contains a ring-shaped front area for the retention on an annular bead of the housing.

10. Plug connection according to claim 6, wherein the securing element contains a ring-shaped rear area for the placement on and for the retention on the clamping element.

11. Plug connection according to claim 6, wherein the securing element contains slot-shaped recesses for the engagement of retaining bars of the clamping element.

12. Plug connection according to claim 1, wherein the receiving opening of the housing contains an inner ring-shaped shoulder as abutment for the connection pipe and an inner ring shoulder for the application of a ring-shaped sealing.
